(19) United States
(12) Patent Application Publication
(10) Pub. No.: US 2008/0297811 A1
(43) Pub. Date: Dec. 4, 2008

(54) User interface presentation of page layout output mimics for multiple-image up jobs

(75) Inventors: Thomas Lippincott Pierce, Rochester, NY (US); Suzanne M. Peebles, Pittsford, NY (US); Marc J. Krolczyk, Spencerport, NY (US)

Correspondence Address: FAY SHARPE / XEROX - ROCHESTER, 1100 SUPERIOR AVE., SUITE 700, CLEVELAND, OH, 44114, US

(73) Assignee: XEROX CORPORATION

(21) Appl. No.: 11/809,088

(22) Filed: May 31, 2007

(51) Int. Cl. G06F 15/00

(52) U.S. Cl. 358/1.6

(57) ABSTRACT

An image forming device capable of copying and/or scanning a physical original document is provided. The image forming device includes a User Interface providing an accurate output mimic illustrating a representation of the output sheet having a long edge and a short edge with representations of the one or more original documents arranged in rows and columns thereon each including a long edge, a short edge and an image top for indicating the orientation of the output.

### BACKGROUND

Documents are typically rectangular and not square, having a long edge and a short edge. Images, including text, drawings, photos, etc. can be oriented on the document sheet in one of two ways, in a Portrait orientation in which the top of the image extends along, or points towards, one of the short edges of the document, and in a Landscape orientation in which the top of the image extends along, or points towards, one of the long edges of the document.

A copier can make copies of original documents. A scanner can scan an original document to acquire the document image in an electronic form. Multifunction image forming devices can both scan a document to acquire the image and then reproduce the image on an output sheet, such as paper, or transparencies, or other sheet material, to also function as a copier.

Conventional multi-function image forming devices may query the user for the “Feed Direction” of the Original document, asking the user to indicate either that the document is being fed, or provided, to the device in the “head to top” direction, in the “head to left direction”, etc.

These devices cannot provide the User with a single, accurate visual representation of the expected output, known as a mimic, for a copying job that will generate multiple images on an output sheet. For these jobs, referred to as multiple-up or repeat image jobs, these conventional devices can only create mimics represented as either squares, which do not provide orientation information, or else they give several possible orientations that may result, since further information is needed to provide a single, accurate mimic.

Accurately predicting the printed layout of a multiple-up job by graphically presenting an accurate representation to the User has historically been difficult or impossible by the User Interface of a conventional scanning/copying multi-function image forming device. The presentation of a mimic prior to scanning, for multiple-up jobs (including N-up of different images, same image repeated multiple times, or any other job involving N to 1 image processing (e.g. booklets)) have historically been a “best guess” presentation to the User. Important pieces of information regarding the User's originals were typically unknown (or un-gathered) and thus accurate mimics were not possible. Unlike a print driver, where specific information about the images “to-be-printed” are known, the local User Interface (UI) for the multi-function image forming device had to “Guess” about the image orientation of the originals the user is providing, and the feed direction of those originals. As a result, the UI could not give the User a single, accurate preview, also known as a “mimic”, of the job on the UI display.

### BRIEF DESCRIPTION

A method of scanning and/or copying one or more physical original documents with an image forming device includes collecting information from a User providing the one or more physical original documents to the image forming device for scanning and/or copying, and determining Multiple Image Page Layout information indicating that a plurality of images will be formed in rows and columns on one side of an output sheet, the Multiple Image Page Layout information including one of a Repeat Image indicator indicating that the plurality of images will include a single image repeated a plurality of times and a Multiple-Up indicator indicating that the plurality of images will include a plurality of different images, and providing a visually displayed Output Mimic to the User displaying a single representation of the output sheet having a long edge and a short edge with representations of the one or more original documents arranged in rows and columns thereon each including a long edge, a short edge and an image top for indicating the page layout of the output sheet.

A User Interface for a multifunction image forming machine includes an Output Mimic visually displaying a representation of the output sheet having a long edge and a short edge with representations of the one or more original documents arranged in rows and columns thereon each including a long edge, a short edge and an image top for indicating the page layout of the output sheet.

### BRIEF DESCRIPTION OF THE DRAWINGS

FIG. 1 is a block diagram of a multi-function image forming machine;

FIG. 2 is a block diagram of a top view of a multi-function image forming machine;

FIG. 3 is a diagram of a portion of a User Interface for a multi-function image forming machine;

FIG. 4 is a diagram of a portion of a User Interface for a multi-function image forming machine illustrating an output mimic in 4 pages up Repeat Image mode;

FIG. 5 is a diagram of a portion of a User Interface for a multi-function image forming machine illustrating an output mimic in Variable Repeat image mode;

FIG. 6 is a diagram of a portion of a User Interface for a multi-function image forming machine illustrating an output mimic in Multiple-Up mode;

FIG. 7 is a diagram of a portion of a User Interface for a multi-function image forming machine illustrating an output mimic in Variable Multiple-Up image mode;

FIG. 8 is a flow chart illustrating a method of generating an output mimic for a multi-function image forming machine in multiple image mode;

FIG. 9 is a flow chart illustrating a method of generating an output mimic for a multi-function image forming machine in multiple image mode;

FIG. 10 is a flow chart illustrating a method of generating an output mimic for a multi-function image forming machine in multiple image mode;

FIG. 11 is a flow chart illustrating a method of generating an output mimic for a multi-function image forming machine in multiple image mode;

FIG. 12 is a flow chart illustrating a method of generating an output mimic for a multi-function image forming machine in multiple image mode; and

FIG. 13 is a flow chart illustrating a method of generating an output mimic for a multi-function image forming machine in multiple image mode.

### DETAILED DESCRIPTION

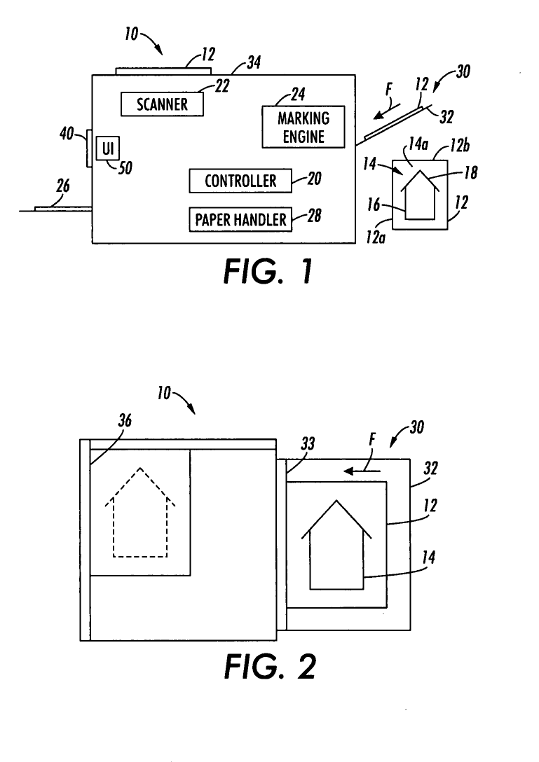

With reference to FIG. 1, an image forming machine or device capable for scanning and/or copying a physical original document 12 is shown generally at 10. The document 12 is rectangular having a long edge 12a and a short edge 12b. The document 12 includes an image 14 to be scanned and/or copied by the device 10. The image 14 can be text, pictures, symbols, etc. and includes an image orientation having an image top 14a. In the example provided, the image 14 is a house 16 having a pointed roof 18 forming the image top 14a.

The device 10 includes a controller 20 for controlling the operation of the device. The controller 20 is one or more computers or other electronic controllers capable of running programmed logic instructions and performing control operations for operating the device 10, including necessary image processing for image manipulations, rotations, sizing, etc. The image forming device 10 also includes a scanner 22 for capturing the image of the original document 12 in electronic form in a known manner. The image forming device 10 can also include a marking engine 24 for forming the image acquired by the scanner 22 on one or more output sheets 26, such as paper, transparencies, or the like, to produce a copy of the original document 12. The marking engine can be a Xerographic engine, or any other known device for forming images on the output sheets 26. The device 10 also includes a paper handler 28 controlled by the controller 20 for moving the original document 12 through the device, storing and providing the output sheets 26, and post processing the output sheets, such as stapling, sorting, etc.

The original document 12 is provided in physical form to the image forming device 10 for scanning and/or copying. The device 10 can include an automatic document feeder (ADF) 30 typically having a tray 32 extending from the device 10 on which the document 12 is placed by a User intending to scan and/or copy it. The ADF feeds the document 12 into the machine 10 as shown by arrow F at the start of the scanning/copying operation. The document feed tray 32 includes a feed edge 33, typically formed along the edge of the device housing into which the document is fed. The device 10 can also include a platen 34, typically formed of glass or other clear material on which the document is placed for scanning and/or copying. The platen 34 includes a registration edge 36, which can be a single line/edge or a corner, and the document is placed against the registration edge by the User to provide proper positioning of the original document for processing. The document 12 is typically placed face down on the platen 34 with the image 14 facing the platen, as shown by illustrating the image with dashed lines.

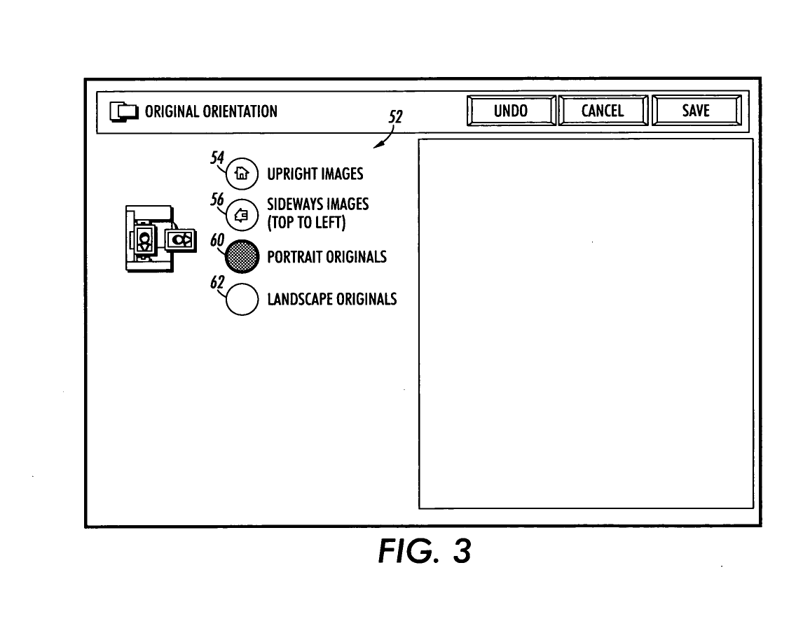

Referring now to FIGS. 1 and 3, the image forming device 10 also includes a User Interface (UI) 50 provided to the person operating the device, referred to herein as the User, on a display 40 such as an LCD touchscreen display or other know type of display extending from the device. The UI 50 provides the User with information about the operation of the device 10. The UI 50 can also be used to collect information from the User in order to operate in a manner the User intends.

The UI 50 includes an Original Orientation section 52 for illustrating and/or collecting information indicating the orientation of the image on the Original Document (referred to hereinafter as the Original Document Orientation (ODO)) that is being provided to the image forming device 10. The Original Orientation section 52 includes an Upright indicator 54 for indicating that the original document 12 is being provided to the device 10 in an upright orientation such that the image top of the image is pointing away from the User standing at the device.

The Original Orientation section 52 also includes a Sideways indicator 56 for indicating that the original document 12 is being provided to the device 10 in a sideways orientation such that the image top of the image is pointing towards the Feed edge 33 of the device 10 or pointing towards a registration edge 36 of the device.

The Original Orientation section 52 also includes a Portrait indicator, shown selected at 60, for indicating that the image 14 on the original document 12 being provided to the device for scanning/copying is arranged in the Portrait orientation, that is to say ODO=Portrait. Portrait orientation is defined as the image top 14a extending along a short edge 12b of the rectangular original document 12. The Portrait indicator 60 can be any suitable icon, or other graphic symbol, word or other representation, which when selected by the User such as by touching it, provides the device 10 information indicating that the image 14 on the original document 12 which is being provided to the device for scanning/copying is arranged in the Portrait orientation.

The Original Orientation section 52 also includes a Landscape indicator 62 for indicating that the image 14 on the original document 12 being provided to the device for scanning/copying is arranged in the Landscape orientation, that is to say ODO=Landscape. Landscape orientation is defined as the image top 14a extending along a long edge 12b of the rectangular original document 12. The Landscape indicator 62 can be any suitable icon, or other graphic symbol, word or other representation, which when selected by the User such as by touching it, provides the device 10 information indicating that the image 14 on the original document 12 which is being provided to the device for scanning/copying is arranged in the Landscape orientation.

The Portrait indicator 60 and Landscape indicator 62 alleviate the User from having to describe how they will be providing the originals to the device 10, that is to say how they will be feeding their originals into the machine. Instead, using either of these two indicators, 60 or 62, the User just inputs what type of original document they are scanning/copying and this enables the machine 10 to determine how to perform the proper rotations and reductions/enlargements.

The UI 50 also includes a Page Layout section 80 for providing the User with an accurate representation, referred to herein as a Mimic 81, of how the output page 26 will look when performing Repeat Image operations or Multiple-Up Image operations as described below.

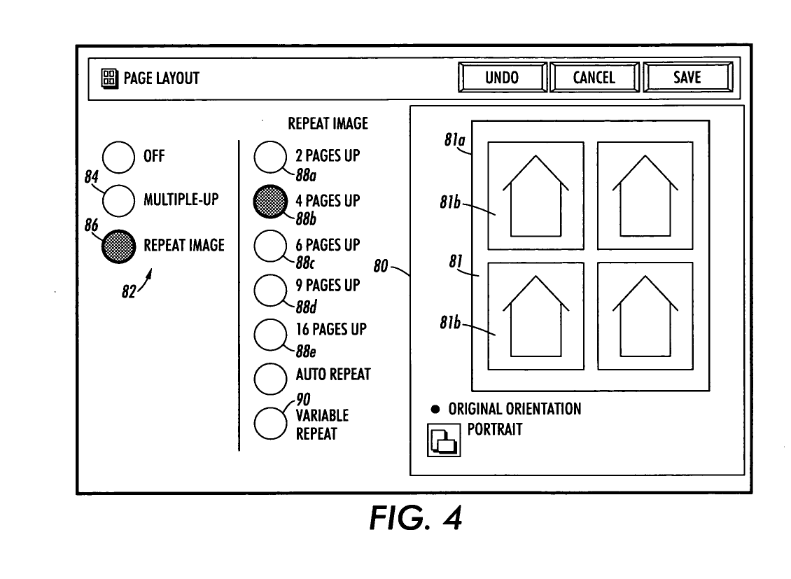

Referring now to FIG. 4, the UI 50 also includes a multiple image selection section 82 for selecting jobs that create multiple images on a single output sheet 26 including a Multiple-Up indicator 84 for selecting a job to copy images from a plurality of physical original documents 12 onto a single output sheet 26, and a Repeat Image indicator 86 for selecting a job to copy images from a single physical original document 12 that is repeated a plurality of times onto a single output sheet. The UI 50 also includes preset repeat image selectors 88 enabling the User to select 2-Up 88a, to repeat the image 2 times on the output sheet in 1 row and 2 columns, or 2 rows and 1 column, or select 4-Up 88b, to repeat the image 4 times on the output sheet in 2 rows and 2 columns, or select 6-Up 88c, to repeat the image 6 times on the output sheet in 2 row and 3 columns, or 3 rows and 2 columns, or select 9-Up 88d, to repeat the image 9 times on the output sheet in 3 rows and 3 columns, or select 16-Up 88e, to repeat the image 16 times on the output sheet in 4 rows and 4 columns.

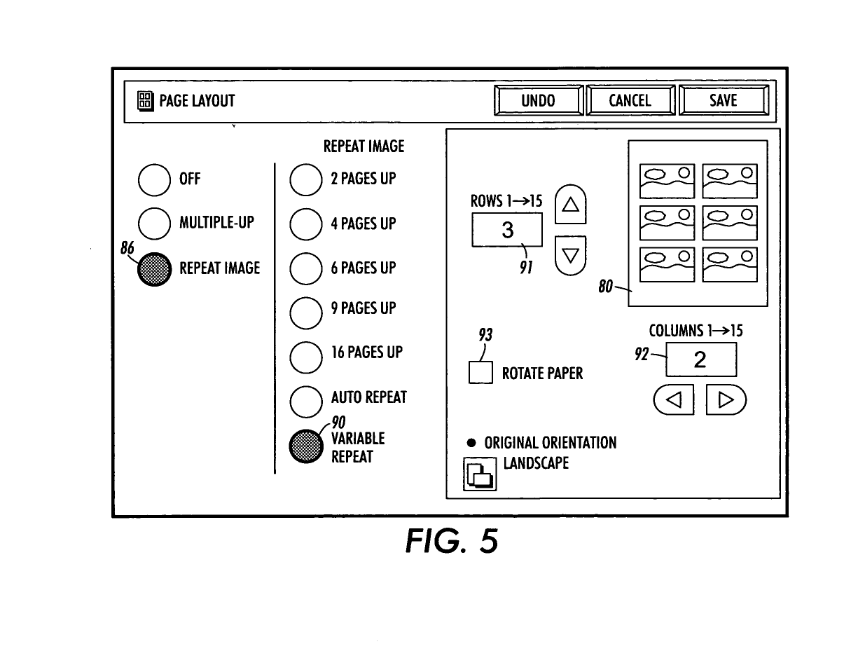

Referring to FIG. 5, the UI 50 also includes a variable repeat 90 indicator enabling the User to select the number of rows N_{R} at 91 of the repeated image, between 1-15, and the number of columns Nc at 92 of the repeated image, between 1-15. The UI 50 can also include a rotate paper indicator 93 in the repeat image section, the selection of which by the User rotates the output sheet 90 degrees from the predicted “best-fit” to provide an alternative output sheet orientation, changing it from Portrait orientation to Landscape orientation or from Landscape orientation to Portrait orientation while maintaining the same ODOR. The change in the output sheet orientation will be shown in the mimic.

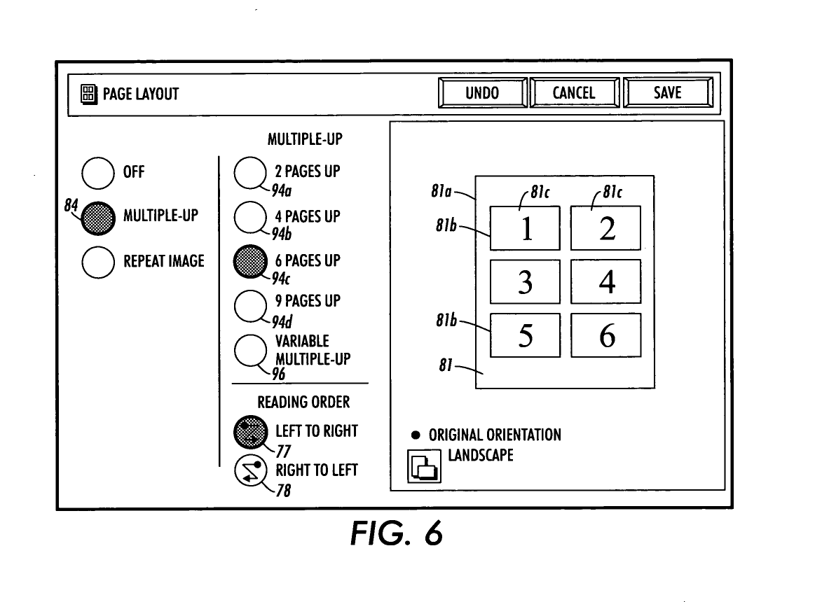

Referring now to FIG. 6, the UI 50 also includes preset multiple image-Up selectors 94 enabling the User to select 2-Up 94a, to copy images from 2 different original documents onto the output sheet and arrange the aggregate image in 1 row and 2 columns, or 2 rows and 1 column, or select 4-Up 94b, to copy images from 4 different original documents onto the output sheet and arrange the aggregate image on the output sheet in 2 rows and 2 columns, or select 6-Up shown selected at 94c, to copy images from 6 different original documents onto the output sheet and arrange the aggregate image on the output sheet in 2 rows and 3 columns, or 3 rows and 2 columns, or select 9-Up 94d, to copy images from 9 different original documents onto the output sheet and arrange the aggregate image on the output sheet in 3 rows and 3 columns. The order of the documents is shown on the mimic using consecutive numbers placed on each representation of an original document, such as for example documents 1-6 as shown in the mimic 80. The reading order, that is the order of the original documents placed on the output sheet 26, can be selected as Left to Right (moving from the top of the document to the bottom) using the left to right indicator 77 as shown in the mimic, or it can be selected as Right to Left (moving from the top of the document to the bottom) using the right to left indicator 78.

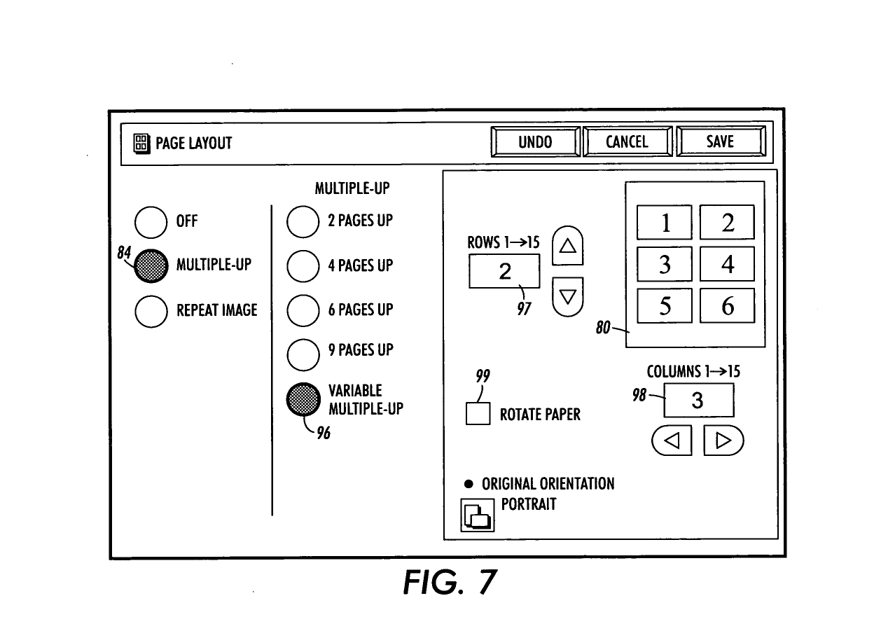

Referring now to FIG. 7, the UI 50 also includes a variable multiple-up indicator 96, selection of which enables the User to input the number of rows N_{R} 97 and the number of columns N_{C} 98 of the images from the different original documents 12 forming the aggregate image to be formed on the output sheet 26. The UI 50 can also include a rotate paper indicator 99 in the multiple-up section, the selection of which by the User rotates the output sheet 90 degrees from the predicted “best-fit” to provide an alternative output sheet orientation, changing the output sheet orientation from Portrait orientation to Landscape orientation or from Landscape orientation to Portrait orientation while maintaining the same orientation of the Original Document on the output sheet as described below. The change in the output sheet orientation will be shown in the mimic.

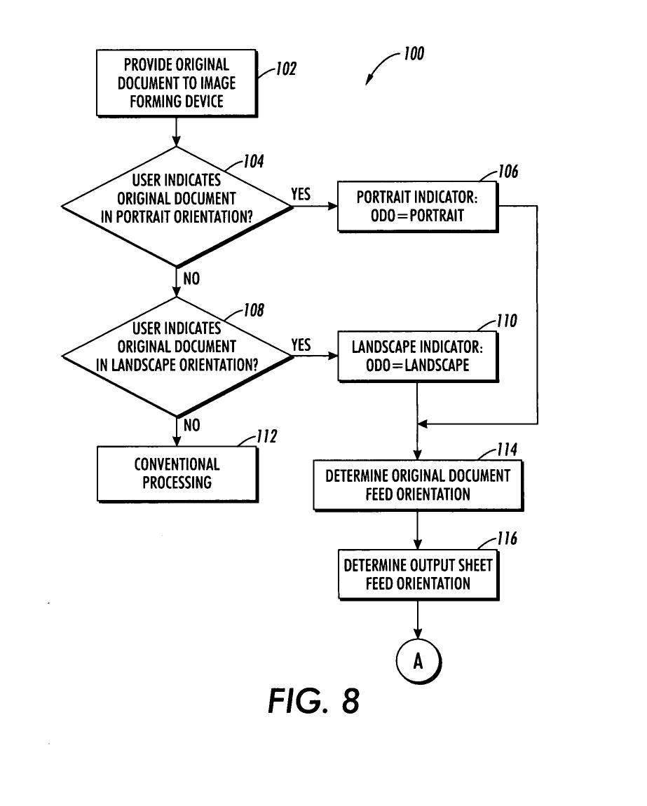

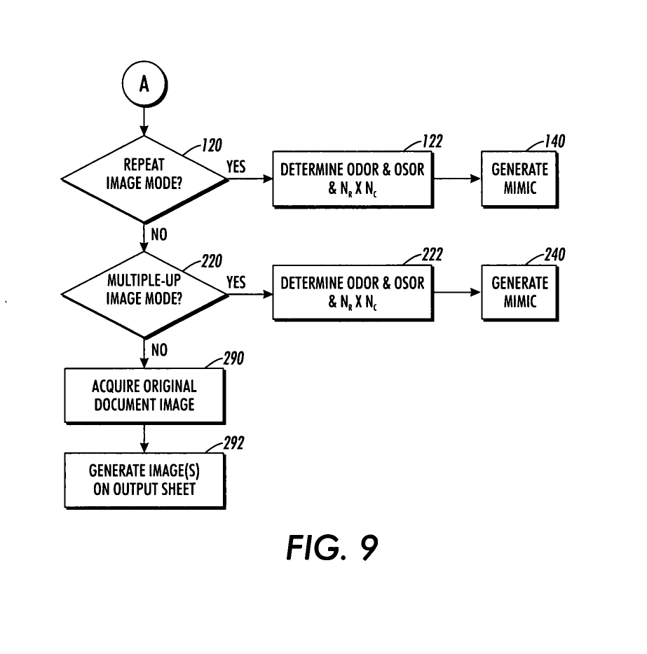

Referring now to FIGS. 8-9, a method of scanning and/or copying one or more physical original documents 12 with an image forming device 10 is shown generally at 100. The one or more physical original documents 12 each have long edge 12a and a short edge 12b and include an image 14 having an image orientation including an image top 14a, as shown in FIG. 1.

The method 100 includes providing the original document, in physical form, to the image forming device at 102. As described above, the original document can be placed in the ADF 30 of the device 10, by placing it on the ADF tray 32, or it can be placed on the platen 34, against the registration edge or corner 36.

The method 100 can also include collecting Original Document Orientation Information from the User at 104 indicating that the Original Document has an image formed thereon in the Portrait Orientation. This information can be provided by the User selecting the Portrait Indicator on the User Interface 50. The Original Document Orientation is therefore determined to be Portrait at 106.

The method 100 can also include collecting Original Document Orientation Information from the User at 108 indicating that the Original Document has an image formed thereon in the Landscape Orientation. This information can be provided by the User selecting the Landscape Indicator on the User Interface 50. The Original Document Orientation is therefore determined to be Landscape at 110.

If the Original Document Orientation Information is not collected from the User, conventional job processing occurs at 112.

The method 100 can also include determining the original document feed orientation at 114. This can be accomplished using sensors in a known manner. The feed orientation of the original document can include Short Edge Feed in which the short edge 12b of the original document 12 is being fed towards the feed edge 33 or the registration edge 36 of the image forming device 10. Alternatively, the original document feed orientation can be Long Edge Feed in which the long edge 12a of the original document 12 is being fed towards the feed edge 33 or the registration edge 36 of the image forming device 10. Original documents with both short edge feed and long edge feed can be processed in the same job, referred to as mixed sized originals, and the controller 20 can determine the correct orientation based on the Original Document Orientation selected for the job.

The method 100 can also include determining the output sheet feed orientation at 116. The feed orientation of the output sheet 26 can include Short Edge Feed in which a short edge 26b of the output sheet 26 is the first edge being fed out of the marking engine 24 of the image forming device 10. Alternatively, the original document feed orientation can be Long Edge Feed in which the long edge 26a of the output sheet 26 is the first edge being fed out of the marking engine 24 of the image forming device 10. Since many image forming devices 10 can provide the User with output sheets in either feed orientation, the feed orientation of the actual output sheet being used for the current job should be determined. The orientation can be determined by the selection of the output sheet feed orientation made by the user via the User Interface, or it can be determined using known sensors disposed in the paper handling portion 28 of the device 10, or in any other suitable known manner.

The method 100 can also include determining if multiple images are to be formed on a single output sheet. If the device 10 has been instructed, such as by the User via the User Interface 50, to use Repeat Image mode at 120 a Repeat Image indicator is provided to the controller 20 indicating that the multiple images will include a single image of the Original Document repeated a plurality of times.

The method 100 can also include generating a mimic 81 showing the User a representation of the expected Output Sheet in its proper orientation (referred to hereinafter as the Output Sheet Orientation Representation (OSOR)). The mimic 81 will also show, on the OSOR, representations of the Original Document image in the proper orientation (referred to hereinafter as the Original Document Orientation Representation (ODOR)), repeated the desired number of times and arrayed in rows and columns.

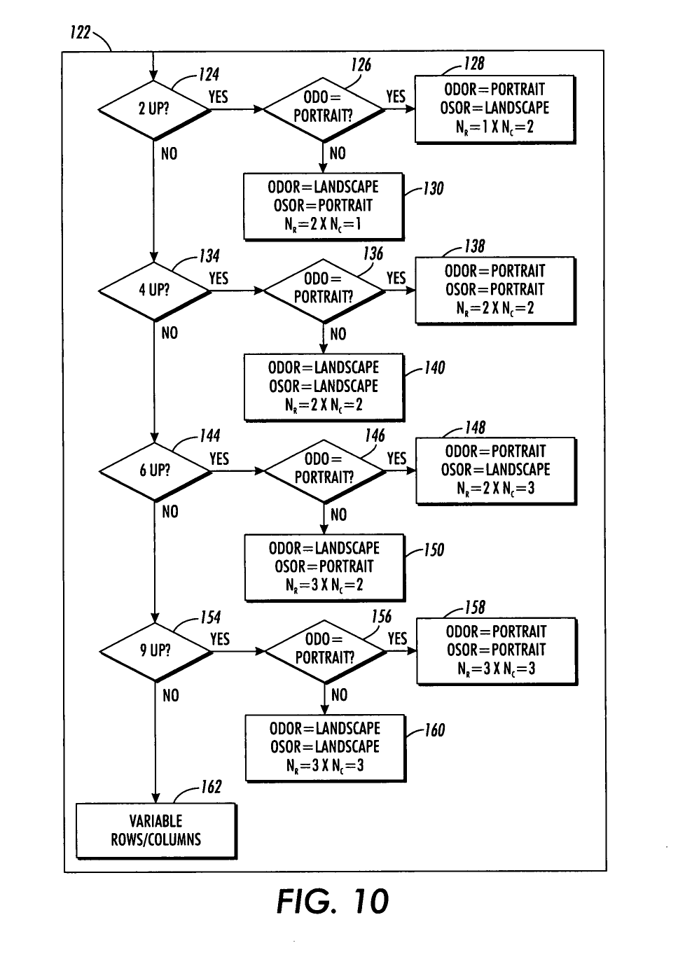

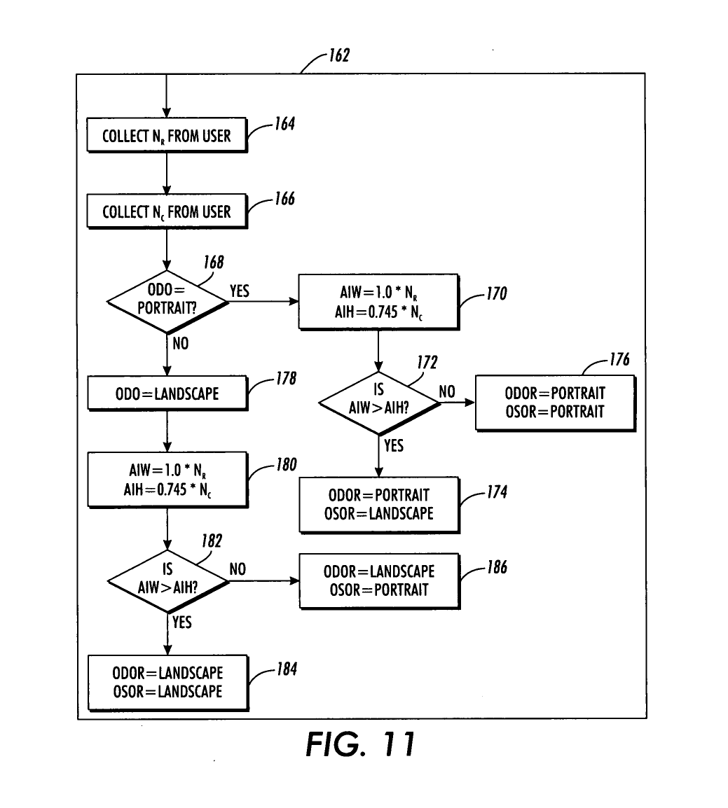

In order to generate the mimic, the OSOR, ODOR and number of rows (N_{R}) of the repeated ODOR and the number of columns (N_{C}) of the repeated ODOR are determined at 122. Referring now to FIG. 10, if two images of the Original Document are selected by the User, via the UI 50, to be repeated on the output sheet at 124 this mode is referred to as 2-UP Repeated Image mode. If, at 126, the Original Document Orientation (ODO) was provided by the User as Portrait then ODOR=Portrait, OSOR=Landscape, N_{R}=1 and N_{C}=2. The mimic is then generated at 140 showing a representation of the Output Sheet (OSOR) in Landscape orientation having 1 row and 2 columns of representations of the Original Document (ODOR) in Portrait orientation including an indication of the long edge and the short edge of the original document as well as an indication of the image top of the original document to properly covey the orientation of ODOR to the User. The OSOR includes a long edge and short edge with the image top facing up, that is towards the top of the display.

If, at 126, ODO was provided by the User as Landscape, then ODOR=Landscape, OSOR=Portrait, N_{R}=2 and N_{C}=1. The mimic is then generated at 140 showing a representation of the Output Sheet (OSOR) in Portrait orientation having 2 rows and 1 column of representations of the Original Document (ODOR) in Landscape orientation including an indication of the long edge and the short edge of the original document as well as an indication of the image top of the original document to properly covey the orientation of ODOR to the User. The OSOR includes a long edge and short edge with the image top facing up, that is towards the top of the display.

If four images of the Original Document are selected by the User, via the UI 50, to be repeated on the output sheet at 134 this mode is referred to as 4-UP mode. If, at 136, the ODO was provided by the User as Portrait then ODOR=Portrait, OSOR=Portrait, N_{R}=2 and N_{C}=2. The mimic is then generated at 140 showing a representation of the Output Sheet (OSOR) 81a in Portrait orientation having 2 rows and 2 columns of representations of the Original Document (ODOR) 81b in Portrait orientation including an indication of the long edge and the short edge of the original document as well as an indication of the image top of the original document to properly covey the orientation of ODOR to the User, as shown by the mimic 81 in FIG. 4. The OSOR includes a long edge and short edge with the image top facing up, that is towards the top of the display.

If, at 126, ODO was provided by the User as Landscape, then ODOR=Landscape, OSOR=Landscape, N_{R}=2 and N_{C}=2. The mimic is then generated at 140 showing a representation of the Output Sheet (OSOR) in Landscape orientation having 2 rows and 2 columns of representations of the Original Document (ODOR) in Landscape orientation including an indication of the long edge and the short edge of the original document as well as an indication of the image top of the original document to properly covey the orientation of ODOR to the User. The OSOR includes a long edge and short edge with the image top facing up, that is towards the top of the display.

Six images of the Original Document can be selected by the User to be repeated on the output sheet at 144 for 6-UP mode. If, at 146, the ODO was provided by the User as Portrait then ODOR=Portrait, OSOR=Landscape, N_{R}=2 and N_{C}=3. The mimic is then generated at 140 showing a representation of the Output Sheet (OSOR) in Landscape orientation having 2 rows and 3 columns of representations of the Original Document (ODOR) in Portrait orientation including an indication of the long edge and the short edge of the original document as well as an indication of the image top of the original document to properly covey the orientation of ODOR to the User. The OSOR includes a long edge and short edge with the image top facing up, that is towards the top of the display.

If, at 146, ODO was provided by the User as Landscape, then ODOR=Landscape, OSOR=Portrait, N_{R}=3 and N_{C}=2. The mimic is then generated at 140 showing a representation of the Output Sheet (OSOR) in Portrait orientation having 3 rows and 2 columns of representations of the Original Document (ODOR) in Landscape orientation including an indication of the long edge and the short edge of the original document as well as an indication of the image top of the original document to properly covey the orientation of ODOR to the User. The OSOR includes a long edge and short edge with the image top facing up, that is towards the top of the display.

Nine images of the Original Document can be selected by the User to be repeated on the output sheet at 154 for 9-UP mode. If, at 156, the ODO was provided by the User as Portrait then ODOR=Portrait, OSOR=Portrait, N_{R}=3 and N_{C}=3. The mimic is then generated at 140 showing a representation of the Output Sheet (OSOR) in Portrait orientation having 3 rows and 3 columns of representations of the Original Document (ODOR) in Portrait orientation including an indication of the long edge and the short edge of the original document as well as an indication of the image top of the original document to properly covey the orientation of ODOR to the User. The OSOR includes a long edge and short edge with the image top facing up, that is towards the top of the display.

If, at 156, ODO was provided by the User as Landscape, then ODOR=Landscape, OSOR=Portrait, N_{R}=3 and N_{C}=3. The mimic is then generated at 140 showing a representation of the Output Sheet (OSOR) in Landscape orientation having 3 rows and 3 columns of representations of the Original Document (ODOR) in Landscape orientation including an indication of the long edge and the short edge of the original document as well as an indication of the image top of the original document to properly covey the orientation of ODOR to the User. The OSOR includes a long edge and short edge with the image top facing up, that is towards the top of the display.

The User can select variable mode at 162 in which the User can select the number of rows and the number of columns in which the Original Document is to be repeated onto the Output Sheet. Referring now to FIG. 5, the User enters the number of rows N_{R}, at 91 using the UI 50, and N_{R} is collected from the user at 164. Similarly, the User enters the number of columns N_{C} at 92 using the UI 50, and N_{C} is collected from the user at 166.

It should be appreciated that, since no in-tray size detection is used by the device 10, the input image size of the Original Document, such as A4 or letter size, etc., is not yet known. Therefore, an idealized paper-edge-ratio value of 0.745 (8.2″×11″ or 221 mm×297 mm) is used as a compromise between the actual paper-edge-ratios of A4 sized paper and Letter-sized paper.

The predicted layout of the aggregate image, composed of the repeated original document image, on the output sheet uses the idealized paper-edge-ratio together with the ODO and the number of rows N_{R} and columns N_{C} forming the aggregate image. The aggregate image may have a different Portrait/Landscape Orientation than that of the individual sub-images forming it (i.e. those of the repeated original document image).

If, at 168, the ODO was provided by the User as Portrait, at 106 above, and the Aggregate Image Width (AIW) is determined as 0.745*N_{C} and the Aggregate Image Height (AIH) is determined as 1.0*N_{R} at 170. If the width of the aggregate image (AIW) is greater than the height (AIH) at 172, the OSOR is determined to be Landscape and the ODOR is Portrait at 174. The mimic 81 is generated at 140 showing a representation of the Output Sheet (OSOR) in Landscape orientation having representations of the Original Document (ODOR) in Portrait orientation arranged on it and repeated for the selected number of rows and columns. The ODOR each include an indication of the long edge and the short edge of the original document as well as an indication of the image top of the original document to properly covey the orientation of ODOR to the User. The OSOR includes a long edge and short edge with the image top facing up, that is towards the top of the display.

If the width of the aggregate image (AIW) is not greater than the height (AIH) at 172, the OSOR shall be Portrait and the ODOR shall be Portrait at 176. The mimic is generated at 140 showing a representation of the Output Sheet in Portrait orientation having representations of the Original Document in Portrait orientation arranged on it and repeated for the selected number of rows and columns. The ODOR each include an indication of the long edge and the short edge of the original document as well as an indication of the image top of the original document to properly covey the orientation of ODOR to the User. The OSOR includes a long edge and short edge with the image top facing up, that is towards the top of the display.

If the ODO is not Portrait, Landscape has been provided at 110 above, and ODO is Landscape as shown at 178. The AIW is 1.0*N_{R} and AIH is 0.745*N_{C} at 180. If the AIW is greater than the AIH at 182, then Landscape is used for the OSOR, as well as the ODOR at 184. The mimic is then generated at 140 showing a representation of the Output Sheet in Landscape orientation having representations of the Original Document in Landscape orientation arranged on it and repeated for the selected number of rows and columns. The ODOR each include an indication of the long edge and the short edge of the original document as well as an indication of the image top of the original document to properly covey the orientation of ODOR to the User. The OSOR includes a long edge and short edge with the image top facing up, that is towards the top of the display.

If the AIW is not greater than the AIH at 182, Portrait is used for the OSOR and the ODOR is Landscape. The mimic is then generated at 140 showing a representation of the Output Sheet in Portrait orientation having representations of the Original Document in Landscape orientation arranged on it and repeated for the selected number of rows and columns. The ODOR each include an indication of the long edge and the short edge of the original document as well as an indication of the image top of the original document to properly covey the orientation of ODOR to the User. The OSOR includes a long edge and short edge with the image top facing up, that is towards the top of the display.

The device 10 can be used to provide a plurality of different Original Documents arrayed in rows and columns in Multiple-Up Image mode at 220. The ODOR, OSOR and N_{R} and N_{C} are determined at 222 in a similar manner as for the Repeat Image Mode described above and the mimic 81 is generated at 240.

If the device 10 has been instructed, such as by the User via the User Interface 50, to use Multiple-Up Image mode at 220 a Multiple-Up Image indicator is provided to the controller 20 indicating that a plurality of different Original document images will arrayed in rows and columns on a single output sheet 26. The method 100 can also include generating a mimic 81 showing the User a representation of the OSOR and showing, on the OSOR, the ODORs of the Original documents in their proper orientation and arrayed in rows and columns.

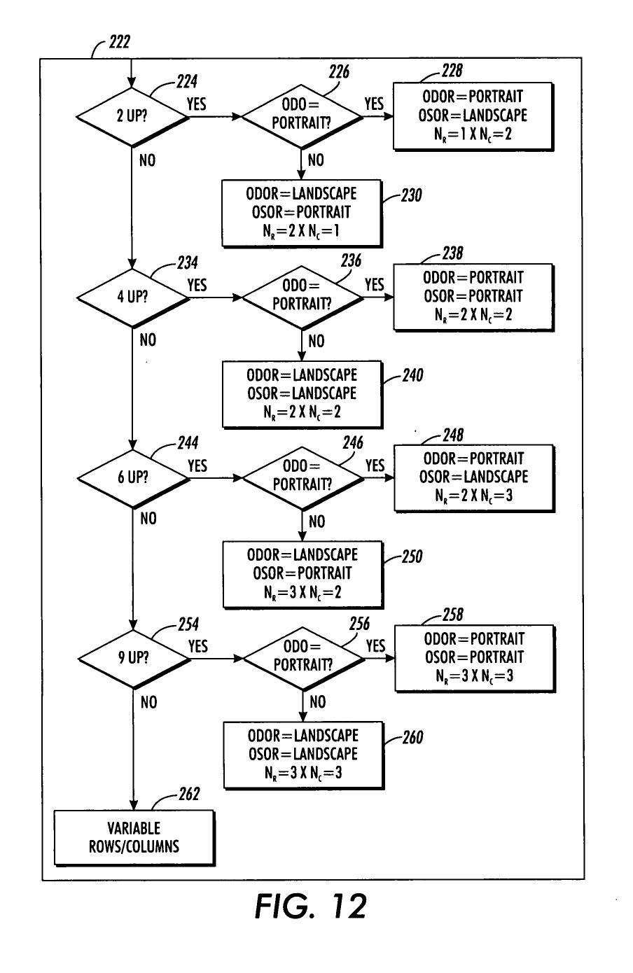

In order to generate the mimic, the OSOR, ODOR and number of rows (N_{R}) and the number of columns (N_{C}) of the ODORs are determined at 222. Referring now to FIG. 12, if two Original Documents are selected by the User, via the UI 50, to be copied onto the output sheet at 224 this mode is referred to as 2-UP mode. If, at 226, the Original Document Orientation (ODO) was provided by the User as Portrait then ODOR=Portrait, OSOR=Landscape, N_{R}=1 and N_{C}=2. The mimic is then generated at 240 showing a representation of the Output Sheet (OSOR) in Landscape orientation having 1 row and 2 columns of representations of the two Original Documents (ODORs) in Portrait orientation. The OSOR includes a long edge and short edge with the image top facing up, that is towards the top of the display. The ODOR each include an indication of the long edge and the short edge of the original document as well as an indication of the image top of the original document to properly covey the orientation of ODOR to the User. Reading order numbers can be included on the ODORs to illustrate the image top of each representation of each original document as well as the order of the documents.

If, at 226, ODO was provided by the User as Landscape, then ODOR=Landscape, OSOR=Portrait, N_{R}=2 and N_{C}=1. The mimic is then generated at 240 showing a representation of the Output Sheet (OSOR) in Portrait orientation having 2 rows and 1 column of representations of the two Original Documents (ODORs) in Landscape orientation. The OSOR includes a long edge and short edge with the image top facing up, that is towards the top of the display. The ODOR each include an indication of the long edge and the short edge of the original document as well as an indication of the image top of the original document to properly covey the orientation of ODOR to the User. Reading order numbers can be included on the ODORs to illustrate the image top of each representation of each original document as well as the order of the documents.

If four of the Original Documents are selected by the User, via the UI 50, to be copied on the output sheet at 234 this mode is referred to as 4-UP mode. If, at 236, the ODO was provided by the User as Portrait then ODOR=Portrait, OSOR=Portrait, N_{R}=2 and N_{C}=2. The mimic is then generated at 240 showing a representation of the Output Sheet (OSOR) in Portrait orientation having 2 rows and 2 columns of representations of the four Original Document (ODORs) in Portrait orientation. The OSOR includes a long edge and short edge with the image top facing up, that is towards the top of the display. The ODOR each include an indication of the long edge and the short edge of the original document as well as an indication of the image top of the original document to properly covey the orientation of ODOR to the User. Reading order numbers can be included on the ODORs to illustrate the image top of each representation of each original document as well as the order of the documents.

If, at 226, ODO was provided by the User as Landscape, then ODOR=Landscape, OSOR=Landscape, N_{R}=2 and N_{C}=2. The mimic is then generated at 240 showing a representation of the Output Sheet (OSOR) in Landscape orientation having 2 rows and 2 columns of representations of the four Original Documents (ODORs) in Landscape orientation. The OSOR includes a long edge and short edge with the image top facing up, that is towards the top of the display. The ODOR each include an indication of the long edge and the short edge of the original document as well as an indication of the image top of the original document to properly covey the orientation of ODOR to the User. Reading order numbers can be included on the ODORs to illustrate the image top of each representation of each original document as well as the order of the documents.

Six Original Documents can be selected by the User to be copied onto the output sheet at 244 for 6-UP mode. If, at 246, the ODO was provided by the User as Portrait then ODOR=Portrait, OSOR=Landscape, N_{R}=2 and N_{C}=3. The mimic is then generated at 20 showing a representation of the Output Sheet (OSOR) in Landscape orientation having 2 rows and 3 columns of representations of the six Original Documents (ODORs) in Portrait orientation. The OSOR includes a long edge and short edge with the image top facing up, that is towards the top of the display. The ODOR each include an indication of the long edge and the short edge of the original document as well as an indication of the image top of the original document to properly covey the orientation of ODOR to the User. Reading order numbers can be included on the ODORs to illustrate the image top of each representation of each original document as well as the order of the documents.

If, at 246, ODO was provided by the User as Landscape, then ODOR=Landscape, OSOR=Portrait, N_{R}=3 and N_{C}=2. The mimic is then generated at 240 showing a representation of the Output Sheet (OSOR) in Portrait orientation having 3 rows and 2 columns of representations of the six Original Documents (ODOR) in Landscape orientation. The OSOR includes a long edge and short edge with the image top facing up, that is towards the top of the display. The ODOR each include an indication of the long edge and the short edge of the original document as well as an indication of the image top of the original document to properly covey the orientation of ODOR to the User. Reading order numbers can be included on the ODORs to illustrate the image top of each representation of each original document as well as the order of the documents.

Nine of the Original Documents can be selected by the User to be copied on the output sheet at 254 for 9-UP mode. If, at 256, the ODO was provided by the User as Portrait then ODOR=Portrait, OSOR=Portrait, N_{R}=3 and N_{C}=3. The mimic is then generated at 240 showing a representation of the Output Sheet (OSOR) in Portrait orientation having 3 rows and 3 columns of representations of the nine Original Document (ODORs) in Portrait orientation. The OSOR includes a long edge and short edge with the image top facing up, that is towards the top of the display. The ODOR each include an indication of the long edge and the short edge of the original document as well as an indication of the image top of the original document to properly covey the orientation of ODOR to the User. Reading order numbers can be included on the ODORs to illustrate the image top of each representation of each original document as well as the order of the documents.

If, at 256, ODO was provided by the User as Landscape, then ODOR=Landscape, OSOR=Portrait, N_{R}=3 and N_{C}=3. The mimic is then generated at 240 showing a representation of the Output Sheet (OSOR) in Landscape orientation having 3 rows and 3 columns of representations of the nine Original Documents (ODORs) in Landscape orientation. The OSOR includes a long edge and short edge with the image top facing up, that is towards the top of the display. The ODOR each include an indication of the long edge and the short edge of the original document as well as an indication of the image top of the original document to properly covey the orientation of ODOR to the User. Reading order numbers can be included on the ODORs to illustrate the image top of each representation of each original document as well as the order of the documents.

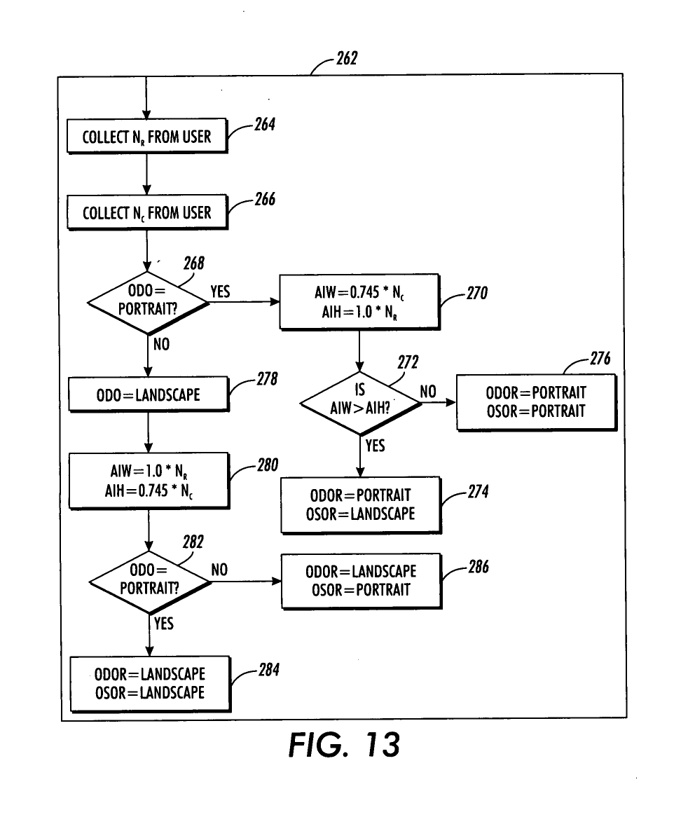

The User can select variable mode at 262 in which the User can select the number of rows and the number of columns in which the Original Document is to be repeated onto the Output Sheet. Referring now to FIGS. 7 and 13, the User enters the number of rows N_{R}, at 97 using the UI 50, and N_{R} is collected from the user at 264. Similarly, the User enters the number of columns N_{C} 98 using the UI, and N_{C} is collected from the user at 266.

It should be appreciated that, since no in-tray size detection is used by the device, the input image size of the Original Document, such as A4 or letter size, etc., is not yet known. Therefore, an idealized paper-edge-ratio value of 0.745 (8.2″×11″ or 221 mm×297 mm) is used as a compromise between the actual paper-edge-ratios of A4 sized paper and Letter-sized paper.

The predicted layout of the aggregate image, composed of the original documents to be copied on the output sheet, uses the idealized paper-edge-ratio together with the ODO and the number of rows and columns forming the aggregate image. The aggregate image may have a different Portrait/Landscape Orientation than that of the individual sub-images forming it (i.e. those images of the original documents).

If, at 268, the ODO was provided by the User as Portrait, at 106 above, and the Aggregate Image Width (AIW) is determined as 0.745N_{C} and the Aggregate Image Height (AIH) is determined as 1.0*NR at 270. If the width of the aggregate image (AIW) is greater than the height (AIH) at 272, the OSOR is determined to be Landscape and the ODOR is Portrait at 274. The mimic 81 is generated at 240 showing a representation of the Output Sheet in Landscape orientation having representations of the Original Documents in Portrait orientation arranged on it in the selected number of rows and columns. The OSOR includes a long edge and short edge with the image top facing up, that is towards the top of the display. The ODOR each include an indication of the long edge and the short edge of the original document as well as an indication of the image top of the original document to properly covey the orientation of ODOR to the User. Reading order numbers can be included on the ODORs to illustrate the image top of each representation of each original document as well as the order of the documents.

If the width of the aggregate image (AIW) is not greater than the height (AIH) at 272, the OSOR shall be Portrait and the ODOR shall be Portrait at 276. The mimic 81 is generated at 240 showing a representation of the Output Sheet in Portrait orientation having representations of the Original Document in Portrait orientation arranged on it in the selected number of rows and columns. The OSOR includes a long edge and short edge with the image top facing up, that is towards the top of the display. The ODOR each include an indication of the long edge and the short edge of the original document as well as an indication of the image top of the original document to properly covey the orientation of ODOR to the User. Reading order numbers can be included on the ODORs to illustrate the image top of each representation of each original document as well as the order of the documents.

If the ODO is not Portrait, Landscape has been provided at 110 above, and ODO is Landscape as shown at 278. The AIW is 1.0*N_{R} and AIH is 0.745*N_{C} at 280. If the AIW is greater than the AIH at 282, then Landscape is used for the OSOR, as well as the ODOR at 284. The mimic 81 is then generated at 240 showing a representation of the Output Sheet in Landscape orientation having representations of the Original Document in Landscape orientation arranged on it in the selected number of rows and columns. The OSOR includes a long edge and short edge with the image top facing up, that is towards the top of the display. The ODOR each include an indication of the long edge and the short edge of the original document as well as an indication of the image top of the original document to properly covey the orientation of ODOR to the User. Reading order numbers can be included on the ODORs to illustrate the image top of each representation of each original document as well as the order of the documents.

If the AIW is not greater than the AIH at 282, Portrait is used for the OSOR and the ODOR is Landscape. The mimic 81 is then generated at 240 showing a representation of the Output Sheet in Portrait orientation having representations of the Original Documents in Landscape orientation arranged on it in the selected number of rows and columns. The OSOR includes a long edge and short edge with the image top facing up, that is towards the top of the display. The ODOR each include an indication of the long edge and the short edge of the original document as well as an indication of the image top of the original document to properly covey the orientation of ODOR to the User. Reading order numbers can be included on the ODORs to illustrate the image top of each representation of each original document as well as the order of the documents.

Referring again to FIG. 9, the method 100 also includes acquiring the original document image 14 using the scanner 22 at 290 in a known manner. The ADF 30 may move the original document into position adjacent (above) the scanner 22 for scanning of the document image, or alternatively, the original document can be placed adjacent the registration edge 36 on the platen 34 as described above. The acquired image can be stored in electronic form by the controller 20 for use as described below.

The method also includes generating the image(s) on the output sheet 292 having the orientations as represented by the mimic generated in 140, 240.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method of scanning and/or copying one or more physical original documents with an image forming device, the one or more physical original documents each having a Long Edge and a Short Edge and an image having an image orientation including an image top, the method comprising:
collecting Original Document Orientation information from a User providing the one or more physical original documents to the image forming device for scanning and/or copying, the information including at least one of Portrait information indicating that the one or more original documents have images arranged in Portrait orientations, and Landscape information indicating that the one or more original documents have images arranged in Landscape orientations;
determining the Feed Orientation of the one or more physical original documents being provided to the image forming device, the Feed Orientation being one of Short Edge Feed and Long Edge Feed relative to one of a feed edge or registration edge of the image forming device;
determining Multiple Image Page Layout information indicating that a plurality of images will be formed in rows and columns on one side of an output sheet, the Multiple Image Page Layout information including one of a Repeat Image indicator indicating that the plurality of images will include a single image repeated a plurality of times and a Multiple-Up indicator indicating that the plurality of images will include a plurality of different images; and
providing a visually displayed Output Mimic to the User displaying a single representation of the output sheet having a long edge and a short edge with representations of the one or more original documents arranged in rows and columns thereon each including a long edge, a short edge and an image top for indicating the page layout of the output sheet.

2. The method defined in claim 1 further comprising:
determining the page layout for one or more output sheets having a plurality of original document images formed thereon using the Original Document Orientation information, the feed orientation and the Repeat Image indicator information.

3. The method defined in claim 1 further comprising:
determining the page layout for one or more output sheets having a plurality of original document images formed thereon using the Original Document Orientation information, the feed orientation and the Multiple-Up indicator information.

4. A User Interface for an image forming device capable of copying and/or scanning a physical original document having a long edge a short edge and an image having an image orientation including an image top comprising:
a User selectable Portrait indicator for indicating that a physical original document having an image arranged in Portrait orientation in either Short Edge Feed or Long Edge Feed is being provided to the device for processing;
a User selectable Landscape indicator for indicating that a physical original document having an image arranged in Landscape orientation in either Short Edge Feed or Long Edge Feed is being provided to the device for processing; and
an Output Mimic visually displaying a representation of the output sheet having a long edge and a short edge with representations of multiple copies of an original document or copies of multiple original documents arranged in rows and columns thereon each including a long edge, a short edge and an image top for indicating the page layout of the output sheet.

5. The image forming device defined in claim 4 wherein the User Interface further comprises:
a rotate paper selector for rotating the output sheet ninety degrees, wherein the rotated output paper is represented in the mimic while retaining the previously determined layout of the original document images.
